(19) United States
(12) Patent Application Publication
(10) Pub. No.: US 2023/0086584 A1
(43) Pub. Date: Mar. 23, 2023

(54) METHOD AND SYSTEM FOR IDENTIFYING ONE OF A BALL IMPACT AND A CUSTOM TAP

(71) Applicant: Spektacom Technologies Private Limited, Bengaluru (IN)

(72) Inventors: Anil Kumble, Bengaluru (IN); Abhishek Binaykia, Ahmedabad (IN)

(21) Appl. No.: 17/904,533

(22) PCT Filed: Jan. 18, 2021
(86) PCT No.: PCT/IN2021/050047

§ 371 Date: Aug. 18, 2022

(30) Foreign Application Priority Data
Jan. 18, 2020 (IN) 202041000867

(51) Int. Cl. A63B 69/00; G06V 40/20

(52) U.S. Cl. CPC A63B 69/0015; G06V 40/23; A63B 2102/20

(57) ABSTRACT

The present disclosure provides a method and system for identifying one of a ball impact and a custom tap on a sports equipment. The method encompasses receiving in real time, at a stump box [102] from one or more accelerometer sensors [202] placed in at least one smart sticker [102], at least one acceleration data associated with a sports equipment [106], The method thereafter leads to identifying, by the stump box [102], a correlation value associated with an identified at least one acceleration pattern based on at least one preconfigured acceleration pattern. Thereafter, one of a positive indication and a negative indication based on a comparison of the at least one correlation value with a correlation threshold value is generated at the stump box [102] and one of the ball impact and the custom tap is then identified based on the positive indication and the negative indication, respectively.

### TECHNICAL FIELD

The present disclosure relates to the field of sports technology. More particularly, the present disclosure relates to identifying one of a ball impact and a custom tap based on at least one sports data collected by at least one smart sticker mounted on a sports equipment.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

With the improvement of technology and standard of living of people, there has been more and more people indulgence in sports, especially in cricket, tennis, badminton, baseball, ice hockey and other ball games. When participating in such games, people exercise and improve their physical fitness, along with the spirit of competition by participating in tournaments. With further developments in computer technology, data analysis for sports in recent years has also vigorously developed. Through the collection and analysis of motion data, participants can get physical data of the sport, as well as suggestions for improving movements and tactics in order to enhance the success rate.

One of the examples of data collection and analysis in the field of cricket is for edge detection, wherein in order to determine whether or not the ball has hit the bat, audio data from the bat around the time of the impact is required to be acquired and assessed. This is then assessed in view of the camera feed from various cameras placed at different angles and location in the stadium. Together, such audio and camera technology is used for edge detection.

Also, there are many solutions for providing such sports data and analysis of said sports data, but these currently known solutions have many limitations and there is a need for improvement in this area of technology. The known solutions typically use or rely on piezoelectric sensors for detecting an impact on a sports equipment. Typically, three piezoelectric sensors are used to sense impact data and the same is processed to identify the impact. Use of multiple sensors is however disadvantageous for numerous reasons. Firstly, piezoelectric sensors are usually temperature sensitive, so the readings from piezo sensors vary over time based on the temperature. Secondly, the output from piezoelectric sensors are very low so external additional circuitry is required to be connected to retrieve readings. Piezoelectric sensors are highly dependent on assembly and placement, and readings may vary in different placement and thus reliability on such data is an issue. Therefore, there is a requirement to provide more efficient and effective sports data to identify ball impact and other impact such as tap.

### SUMMARY

This section is provided to introduce certain aspects of the present disclosure in a simplified form that are further described below in the detailed description. This summary is not intended to identify the key features or the scope of the claimed subject matter.

An aspect of the disclosure relates to a method for identifying one of a ball impact and a custom tap. The method encompasses receiving in real time, at a transceiver unit of a stump box from one or more accelerometer sensors placed in at least one smart sticker, at least one acceleration data associated with a sports equipment, wherein the at least one smart sticker is mounted on the sports equipment. The method further encompasses identifying, by a processing unit of the stump box, at least one acceleration pattern based on the at least one acceleration data. Thereafter the method comprises identifying, by the processing unit of the stump box, at least one correlation value associated with the identified at least one acceleration pattern based on at least one preconfigured acceleration pattern. Further the method encompasses generating, by the processing unit of the stump box, one of a positive indication and a negative indication based on a comparison of the at least one correlation value with a correlation threshold value, wherein the positive indication is generated in an event the at least one correlation value is lesser than the correlation threshold value, and the negative indication is generated in an event the at least one correlation value is greater than the correlation threshold value. Thereafter the method leads to identifying, by the processing unit of the stump box, one of the ball impact and the custom tap, wherein the ball impact is identified based on the positive indication and the custom tap is identified based on the negative indication.

Another aspect of the disclosure relates to a stump box for identifying one of a ball impact and a custom tap. The stump box comprises a transceiver unit, configured to receive in real time from one or more accelerometer sensors placed in at least one smart sticker, at least one acceleration data associated with a sports equipment, wherein the at least one smart sticker is mounted on the sports equipment. The stump box also comprises a processing unit configured to identify, at least one acceleration pattern based on the at least one acceleration data. The processing unit is further configured to identify, at least one correlation value associated with the identified at least one acceleration pattern based on at least one preconfigured acceleration pattern. Further the processing unit is configured to generate, one of a positive indication and a negative indication based on a comparison of the at least one correlation value with a correlation threshold value, wherein the positive indication is generated in an event the at least one correlation value is lesser than the correlation threshold value, and the negative indication is generated in an event the at least one correlation value is greater than the correlation threshold value. The processing unit is further configured to identify, one of the ball impact and the custom tap, wherein the ball impact is identified based on the positive indication and the custom tap is identified based on the negative indication.

Yet another aspect of the disclosure relates to a server for identifying one of a ball impact and a custom tap. The server comprises a transceiver unit, configured to receive via a stump box in real time from one or more accelerometer sensors placed in at least one smart sticker, at least one acceleration data associated with a sports equipment, wherein the at least one smart sticker is mounted on the sports equipment. The server further comprises a processing unit configured to identify, at least one acceleration pattern based on the at least one acceleration data. The processing unit is further configured to identify, at least one correlation value associated with the identified at least one acceleration pattern based on at least one preconfigured acceleration pattern. Thereafter the processing unit is configured to generate, one of a positive indication and a negative indication based on a comparison of the at least one correlation value with a correlation threshold value, wherein the positive indication is generated in an event the at least one correlation value is lesser than the correlation threshold value, and the negative indication is generated in an event the at least one correlation value is greater than the correlation threshold value. Further the processing unit is configured to identify, one of the ball impact and the custom tap, wherein the ball impact is identified based on the positive indication and the custom tap is identified based on the negative indication.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure.

FIG. 1 illustrates an exemplary diagram [100] indicating a connection between a stump box [102] and a smart sticker [104], in accordance with exemplary embodiments of the present disclosure.

FIG. 2 illustrates an exemplary block diagram of a smart sticker [104] for identifying one of a ball impact and a custom tap, in accordance with exemplary embodiments of the present disclosure.

FIG. 3 illustrates an exemplary block diagram of a stump box [102] for identifying one of a ball impact and a custom tap, in accordance with exemplary embodiments of the present disclosure.

FIG. 4 illustrates an exemplary block diagram of a server [400] for identifying one of a ball impact and a custom tap, in accordance with exemplary embodiments of the present disclosure.

FIG. 5 illustrates an exemplary method flow diagram depicting a method [500] for identifying one of a ball impact and a custom tap, in accordance with exemplary embodiments of the present disclosure.

The foregoing shall be more apparent from the following more detailed description of the embodiments of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

As disclosed in the background section the existing technologies have many limitations and in order to overcome at least some of the limitations of the prior known solutions, the present disclosure provides a solution for identifying an impact on a sports equipment such as a ball impact (i.e. a force/impact applied by a ball) and a custom tap (i.e. a general force other than the force applied by the ball). The present disclosure also provides a solution for determining sports parameters such as a parameter associated with an impact on the sports equipment, a parameter associated with a swing of the sports equipment and the like. Furthermore, such sports parameters are determined based on a data received from a smart sticker, a data associated with the ball impact, a data associated with the custom tap, a data associated with the one or more camera sensors and a data associated with the one or more microphones. The smart sticker may be any advertisement sticker or normal sticker mounted on the sports equipment and a number of sensors along with other electronic components are placed in the smart sticker. Further, in order to identify the ball impact and the custom tap on the sports equipment, the present disclosure encompasses a use of the sports data collected by sensors placed in the smart sticker. Also, the smart sticker as disclosed in the present disclosure operates in a number of modes such as in a standby mode components of the smart sticker are in a wakeup state and waits for an event such as a batting state, in a sleep mode the smart sticker is in a sleep state waits for the wakeup state, in an active mode the smart sticker acquires and transmit the sports data and in a storage mode the smart sticker acquire and stores the sports data in a memory unit. The smart sticker also receives commands form units such as a stump box, a boundary device, a user device and a server unit, to collect, analyze/process and transmit a sports data. In an implementation, the invention encompasses that the smart sticker receives a command from the stump box to acquire data, referred herein as a data acquisition command. Upon receiving such data acquisition command, the smart sticker starts acquiring data from a plurality of sensors placed on the smart sticker. Thus, in such implementation data acquisition is dependent on a manual start command coming from a remote server and a remote user can acquire and store as much sensor data as desired by the remote user. Also, if a data acquisition stop command is received, the smart sticker stops data acquisition, storage and transmission. In another instance of the present invention, the smart sticker receives commands for enquiring battery information. For instance, if a battery detail start command is received at the smart sticker, the smart sticker transmits battery voltage, current and charge percentage in the interval of 2 seconds. Furthermore, the invention encompasses starting transmitting to the stump box, the remote server and the user device, the data associated with the plurality of sensors placed on the smart sticker, in an event an impact on the sports equipment is detected by the smart sticker placed on the sports equipment.

As used herein, ‘ball impact’ refers to an impact of a ball on the sports equipment and ‘custom tap’ is any general impact/force (i.e. impact other than the ball impact) on the sports equipment.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, "a user equipment", "a user device", "a smart-user-device", "a smart-device", "an electronic device", "a mobile device", "a handheld device", "a wireless communication device", "a mobile communication device", "a communication device" may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a display unit, a transceiver unit, a server unit and any other such unit(s) which are obvious to the person skilled in the art and are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the server/stump box/smart sticker/user device to perform their respective functions.

As used herein, the “wireless network” may include, but not limited to any private or public wireless network that may be presently implemented or deployed, and any wireless network that may be deployed in the future, or any other such wireless network technology obvious to a person skilled in the art. The wireless network is capable of providing one of a long-range and short-range wireless communication.

As used herein, a “transceiver unit” may comprise one or more transmitter units and one or more receiver units, configured to transmit and receive respectively, at least one of one or more signals, data and commands from various units/modules to implement the features of the present disclosure. The transceiver unit may be any such transmitting and receiving unit known to the person skilled in the art, to implement the features of the present disclosure.

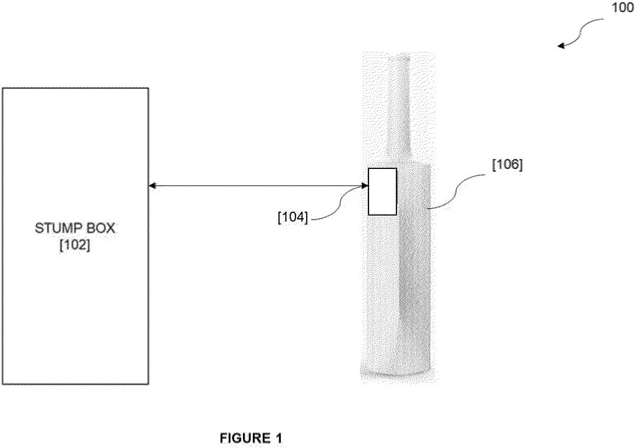

The present disclosure is further explained in detail below with reference now to the diagrams. Referring to FIG. 1, an exemplary diagram [100] indicating a connection between a stump box [102] and a smart sticker [104], in accordance with exemplary embodiments of the present disclosure is shown.

As shown in FIG. 1, the smart sticker [104] is mounted on a sports equipment (i.e. a cricket bat) [106]. The smart sticker [104] is connected to the stump box [102] over a wireless communication channel/wireless network to transmit at least one sports data to the stump box [102] and also to receive at least one command/request from the stump box [102]. In an implementation, the wireless communication channel is a Bluetooth channel between the smart sticker [104] and the stump box [102]. Also in another implementation the wireless communication channel may be established based on any other wireless technologies such as Wi-Fi, Zigby etc. Also, in FIG. 1 only few units are shown, however there may be any such numbers of the units, obvious to a person skilled in the art or as required to implement the features of the present disclosure.

In order to identify one of a ball impact and a custom tap on the sports equipment, at least one sports data is collected by at least one smart sticker mounted on the sports equipment. Thereafter, said collected sports data is transmitted to the stump box [102]. The stump box [102] thereafter identifies one of the ball impact and the custom tap based on the sports data, wherein the sports data comprises at least an acceleration data.

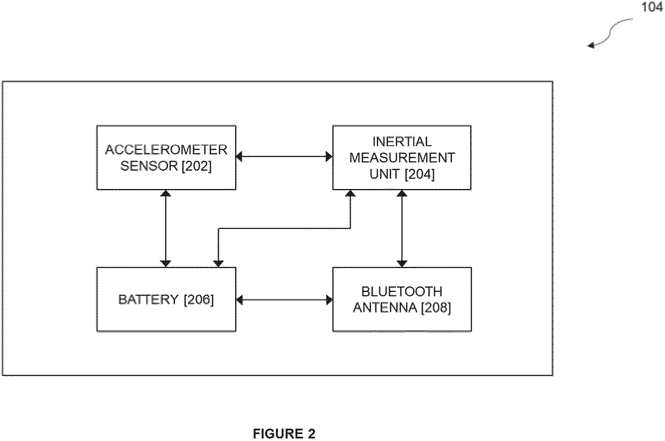

Further, an exemplary block diagram of a smart sticker [104] for identifying one of the ball impact and the custom tap, in accordance with exemplary embodiments of the present disclosure is shown in FIG. 2. As shown in FIG. 2, the smart sticker [104] comprises one or more accelerometer sensors [202], one or more inertial measurement unit (IMU) [204], one or more batteries [206] and a Bluetooth antenna [208]. All of these components/ units of the smart sticker [104] are assumed to be connected to each other unless otherwise indicated below. Also, in FIG. 2 only few units are shown, however the smart sticker [104] may comprise multiple such units or the smart sticker [104] may comprise any such units/numbers of the units, obvious to a person skilled in the art or as required to implement the features of the present disclosure.

Further, in an implementation each of the one or more accelerometer sensors [202] may be a low power accelerometer sensors configured to determine velocity of the sports equipment in a low power mode of operation. The invention encompasses that each of the one or more accelerometer sensors may be a 3-axis high frequency accelerometer sensor. Also, in another implementation the one or more accelerometer sensors [202] are configured to collect at least one acceleration data associated with a sports equipment (such as the cricket bat) [106]. Also, the at least one acceleration data may include but not limited to at least one data associated with an impact on the sports equipment. The data associated with the impact comprises an indication of the impact/tap detection on the sports equipment. Also, the data associated with the impact is determined by the one or more accelerometer sensors [202] based on an analysis of one or more samples of the one or more accelerometer sensors [202] for a fixed period of time, a detection of at least one spike summation value based on the analysis of the one or more samples and a comparison of the at least one spike summation value with at least a low threshold value.

For example, a spike in each of the X axis, Y axis and Z axis is determined based on taking sample acceleration values along each of the X axis, Y axis and Z axis of an accelerometer, respectively. Further, a spike summation value is calculated as a total spike (TSi) based on the spike in each of the X axis, Y axis and Z axis. Further at least one total spike value is compared with at least a low threshold value to identify an impact. For example, in an implementation, if one or more total spike values exceeds the low threshold value for a fixed time period, an impact is detected.

Further, each of the one or more inertial measurement unit [204] comprises at least one multi-axis accelerometer and at least one multi -axis gyroscope. The multi-axis accelerometer may be a 3-axis accelerometer and the multi -axis gyroscope may be a 3-axis gyroscope. The one or more inertial measurement unit (IMU) [204] is configured to collect at least one linear dynamic motion data and at least one angular dynamic motion data of the sports equipment [106], wherein the at least one linear dynamic motion data and the at least one angular dynamic motion data is collected by the at least one multi-axis accelerometer and the at least one multi-axis gyroscope, respectively. In an implementation, a twist of the sports equipment [106] is further identified based on the data collected by the multi-axis gyroscope and a velocity of the sports equipment [106] is further identified based on the data collected by the multi-axis accelerometer. Furthermore, the present disclosure encompasses these and other sensors, data from which may be used to determine parameters such as a launch angle, a back-lift angle, etc.

More specifically, in a cricket match, data such as gyroscope values and accelerometer values from IMU sensors, values of high frequency accelerometer sensors and/or gravity components etc. are used to determine at least one of a Backlift angle, Backlift direction, Handedness of Batsman, Intended Direction of Shot, Face Angle, Impact Determination, Forward Swing Angle, Twist Angle, Follow Through Angle, Velocity at Impact, Impact Localization, Impact Differentiation, Launch Angle and the like.
1. Backlift angle: As used herein, ‘backlift angle’ is an angle moved by a bat from a stance position to a maximum point in a backward direction. In an implementation the Backlift angle can be determined based on a backlift end point and a start of the backlift, wherein the backlift end point and the start of the backlift can be determined based on a gyroscope value.
2. Backlift direction: As used herein, ‘Backlift direction’ is the angle by which the batsman moves his/her bat away from the body during the backlift. In an implementation, the Backlift direction can be determined based on the start and end of the backlift determined based on the direction of gyroscope values
3. Face angle: As used herein, ‘Face angle’ is the angle the face of the bat makes w.r.t to the straight bat position upon ball impact. The face angle and direction can be determined based on horizontal orientation of the gyroscope.
4. Impact determination: In an implementation, an impact point is determined by assessing the total spike in acceleration. Any sudden spike above the pre-set threshold value is considered as an impact.
5. Forward swing angle: As used herein, ‘Forward swing angle’ is the angle by which the batsman moves the bat in the forward direction from the backlift point to hit the ball. In an implementation, the Forward swing angle from the backlift position till an impact, can be determined based on the end point of the backlift and a start point of the impact.
6. Twist angle: As used herein, ‘Twist angle’ during the impact is an involuntary twist of the bat in the hands of the batsman due to the impact of the ball on the bat. In an implementation, the Twist angle during the impact is determined based on the sudden change of gyroscope values upon ball impact.
7. Follow through angle: As used herein, ‘Follow through angle’ is the angle moved by the bat in the swing direction after the impact. In an implementation, the Follow through angle during the impact is determined by calculating the relative gyroscope values between impact end point to follow through end point.
8. Velocity at impact: A used herein, ‘Velocity of the bat’ at the impact is the velocity at which the bat hits the ball in its forward swing. The velocity at impact can be determined based on the backlift end point, impact point and the accelerometer values from the IMU sensor.
9. Impact Localization: A location of an impact is determined via a pre-trained model, wherein the pre-trained model is trained based on impacting a sports equipment such as a bat multiple times to collect corresponding data from high speed accelerometer sensors.
10. Impact Differentiation: Data from the high speed accelerometer sensors is used to identify with which object (such as a ball, ground, pads, another bat, etc.) the sports equipment/bat has come in contact, when a contact is detected.
11. Launch Angle: Launch angle is the angle the bat face makes w.r.t the ground at the time of impact. In an implementation, the Launch Angle during the impact is determined based on one or more gravity components.

Also, in an implementation, the sensors placed in the smart sticker [104] are connected to a microcontroller via an interface. For instance, multi-axis (or for instance 6-axis) sensors are connected to the microcontroller via Serial Peripheral Interface (SPI). In another instance, each of the Low power Accelerometer is connected to the microcontroller via Serial peripheral Interface (SPI). In yet another instance, a Fuel Gauge is connected to the microcontrollervia Inter Integrated circuit (I2C) Bus.

Further, the battery [206] of the smart sticker [104] may comprise of a wireless battery receiver and charger, a Li-ion thin film battery, a dual buck regulator, and a battery protector IC. The batter protector IC is used to protect the battery from over-voltage, under- voltage, over charge current, over discharge current and short circuit. In an implementation the battery [206] is charged via wireless charging and a specific LED indication is provided to indicate charging. Also, a count of no. of charging and discharging cycles are calculated and stored in the memory unit of the smart sticker [104] as well as transmitted to the stump box [102] as a health packet/data. Further, one or more LED indications are also provided to indicate a battery percentage.

The Bluetooth antenna [208] of the smart sticker [104] is configured to establish a Bluetooth connection with the one or more stump boxes [102] placed in a sports field. In an implementation, a striker side and non-striker side in a cricket match is identified based on a Bluetooth signal strength of the smart sticker [104] connected with the stump box [102]. For example, a striker side strength is a threshold value of Bluetooth signal strength and once the smart sticker [104] is paired with one stump box [102] placed near the stumps, the Bluetooth of the smart sticker [104] blocks detection and pairing from a stump box [102] present at the opposite end unless batsman takes up position at opposite end. Also, in such implementation a data acquisition from the smart sticker [104] is enabled only if the Bluetooth (BLE) is connected and the signal strength is greater than the striker side strength, also there is no storage of sports data in case of poor connection. Further, in such implementation in an active mode of the smart sticker [104], the data acquisition may happen (both striker side, non-striker side) and then after a ball impact collected data is transmitted via the BLE in case of good signal strength or stored in the memory unit of the smart sticker [104] in case of poor signal strength.

Also, the invention also encompasses that the smart sticker [104] establishes a direct connection with a user device such as a mobile phone, to transmit the data collected by the sensors of the smart sticker [104] to the user device. This connection may be a wireless connection, and for example, via the Internet. The user device may then assess the data received from the smart sticker and display the assessed data on the user device. The user device may also transmit the assessed data to one or more other user devices.

Further, the smart sticker [104] is configured to operate in a number of modes such as a standby mode, a sleep/deep sleep mode, an active mode and a storage mode. For example, the smart sticker [104] is configured to, initially, operate in a sleep mode wherein only the at least one low power accelerometer is active in the sleep mode. The smart sticker [104] is configured to wake up from the sleep mode upon the low power accelerometer detecting an acceleration/motion above a predetermined threshold.

Further, the operating modes of the smart sticker [104] are explained as below:

1. Standby Mode: In Standby Mode following are the states of the components of the smart sticker [104]:
1) Microcontroller/processing unit (not shown in FIG. 2) - ON State
2) IMU - ON State
3) One or more accelerometer sensors - OFF State
4) Bluetooth (BLE) - ON State

Furthermore, if any motion > threshold acceleration values for 5s is identified by the IMU of the smart sticker [104], the smart sticker [104] enters in the Standby Mode from the Sleep mode and the Bluetooth operates in a Wakeup and Advertise state.

Also, if a Timeout (such as an inactivity of the sports equipment or for example no motion in a cricket bat) for > 10 min is identified, the smart sticker [104] enters in the Standby Mode from the Active mode. Also, in Standby mode the smart sticker [104] waits for a batting stance/state.

2. Active Mode: In Active Mode following are the states of the components of the smart sticker [104]:
1) Microcontroller/processing unit - ON State
2) IMU - ON State (operating frequency for example: 400 Hz)
3) One or more accelerometer sensors - ON State (operating frequency for example: 6.4 KHz)
4) Bluetooth (BLE) - ON State

Furthermore, if batting stance is identified, the smart sticker [104] enters in the Active Mode from the Standby mode and starts the data acquisition. Also, if an active Bluetooth connection is identified, the smart sticker [104] enters in the Active Mode from the Storage mode. Also, in Active mode the smart sticker [104] is configured to acquire data and on shot detection the data (i.e. the sports data) is transmitted to the stump box [102].

3. Sleep Mode: In Sleep Mode following are the states of the components of the smart sticker [104]:
1) Microcontroller/processing unit - Sleep State
2) IMU - Any motion interrupt State
3) One or more accelerometer sensors - OFF State
4) Bluetooth (BLE) - OFF State

Furthermore, if no motion for 10 min or Low Battery i.e. Battery < 5%, is detected the smart sticker [104] enters in the Sleep/Deep sleep mode from one of the Standby mode and the Storage mode. In such case the data is stored in the memory unit of the smart sticker [104]. Also, in Sleep mode the smart sticker [104] is in a Sleep state and waits for wakeup.

4. Storage Mode: In Storage Mode following are the states of the components of the smart sticker [[104]:
1) Microcontroller/processing unit - ON State
2) IMU - ON State (operating frequency for example: 400 Hz)
3) One or more accelerometer sensors - ON State (operating frequency for example: 6.4 KHz)
4) Bluetooth (BLE) - OFF State

Furthermore, if no active Bluetooth connection is found the smart sticker [104] enters in the Storage Mode. In Storage mode, the smart sticker [104] is configured to acquire data and on shot detection the data (i.e. the sports data) is stored in the memory unit (for instance the NVM of the smart sticker).

### Mode Management

In an implementation, for mode transition the smart sticker [104] is configured to detect an active sports equipment (or for instance an active/moving bat) and a passive/still sports equipment (or for instance a passive bat) in real time. If the bat is passive (i.e. no motion) for greater than a configured idle time limit (for example - 10 min) the sensors of the smart sticker [104] are in a shutdown state and the smart sticker [104] enters in the deep sleep/sleep mode. The sensors of the smart sticker [104] are configured to wake up on movement or a pre-defined motion signature. If the bat is active (any motion) for greater than a configured time limit (for example 5s), the sensors of the smart sticker [104] are configured to receive a trigger (interrupt) from the IMU to wake up and reinitialize.

Furthermore, the smart sticker may be in a circular shape and be placed anywhere on the sports equipment such as on the bottom left or right side of the bat. Also, for the smart sticker [104], the no. of days from full charge to full discharge may vary between 3-5 weeks. Also, in an implementation, the max number of shots in full charge may be upto 500 shots and the number of shots stored in the memory unit may be at least 100 shots. Also, the smart sticker [104], is further configured to synchronize the data collected from various sensors and/or units of the smart sticker [104] to provide the stump box [102], the at least one sports data associated with the sports equipment [106]. For example, the data collected via the IMU [204] and the data collected via the one or more accelerometers [202] (for instance a high acceleration data) is synchronized at a time of a ball impact on the sports equipment [106].

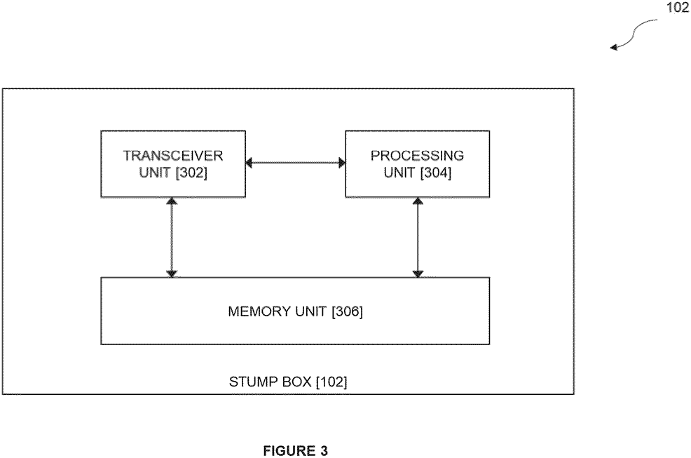

Referring now to FIG. 3, an exemplary block diagram of a stump box [102] for identifying one of a ball impact and a custom tap, in accordance with exemplary embodiments of the present disclosure is shown. In an implementation, the stump box [102] is placed anywhere in a sports field. In another implementation, the stump box [102] is placed near the stumps during a cricket match.

The stump box [102] comprises a transceiver unit [302], configured to receive in real time from one or more accelerometer sensors [202] placed in at least one smart sticker [104], at least one acceleration data associated with a sports equipment [106], wherein the at least one smart sticker [104] is mounted on the sports equipment [106]. In an implementation, the sports equipment [106] is a cricket bat. In another implementation, the sports equipment [106] may be any other sports equipment such as a tennis racquet. Also, the transceiver unit [302] is configured to transmit at least one command, to the at least one smart sticker [104] for at least one of a collecting, processing and transmitting of at least one sports data by the at least one smart sticker [104]. The at least one sports data includes but not limited to one or more data relating to one or more sensors (such as IMU and accelerometers) placed in the at least one smart sticker. Also, the transceiver unit [302] is further configured to receive from the at least one smart sticker [104], the at least one sports data over a wireless connection based on an active mode of the at least one smart sticker. Also, in an instance, the wireless connection is a Bluetooth connection.

Furthermore, the transceiver unit [302] is also configured to receive, at least one data from one or more camera sensors and one or more microphones present in the sports field.

The at least one acceleration data includes but not limited to at least one data associated with an impact on the sports equipment [106]. The data associated with the impact is determined by the one or more accelerometer sensors [202] based on an analysis of one or more samples of the one or more accelerometer sensors [202] for a fixed period of time, a detection of at least one spike summation value based on the analysis of the one or more samples, and a comparison of the at least one spike summation value with at least a low threshold value.

Further, the stump box [102] comprises a processing unit [304] connected to the transceiver unit [302]. The processing unit [304] is configured to identify, at least one acceleration pattern based on the at least one acceleration data. Also, the processing unit [304] is configured to identify, at least one correlation value associated with the identified at least one acceleration pattern based on at least one preconfigured acceleration pattern. Further, the processing unit [304] is configured to generate, one of a positive indication and a negative indication based on a comparison of the at least one correlation value with a correlation threshold value, wherein the positive indication is generated in an event the at least one correlation value is lesser than the correlation threshold value, and the negative indication is generated in an event the at least one correlation value is greater than the correlation threshold value. Further, the processing unit [304] is configured to identify, one of the ball impact and the custom tap, wherein the ball impact is identified based on the positive indication and the custom tap is identified based on the negative indication.

For example, in an implementation AXs, AZs is identified as a set of sampled acceleration data in X axis and Z axis (i.e. identified acceleration pattern) correspondingly from an accelerometer sensor and AXr, AZr is a set of reference acceleration data in X axis and Z axis (i.e. preconfigured acceleration pattern) correspondingly for a tap/impact. A correlation for X axis and Z axis acceleration data is then computed and correlation coefficients (i.e. correlation values) for accelerometer sensors are determined based on the identified acceleration pattern and the preconfigured acceleration pattern.

Further, if mean of the correlation coefficients is greater than a Tap correlation threshold, then a negative indication is generated and the impact is considered as “Tap”, else a positive indication is generated and the impact is considered as “Ball Impact”.

Further, the transceiver unit [302] is also configured to receive in real time from the at least one smart sticker [104], at least one linear dynamic motion data and at least one angular dynamic motion data of the sports equipment [106], wherein the at least one linear dynamic motion data and at least one angular dynamic motion data is received via one or more inertial measurement unit (IMU) [204] placed in the at least one smart sticker [104], Also, each of the one or more inertial measurement unit [204] further comprises at least one multi-axis accelerometer and at least one multi-axis gyroscope. Also, the transceiver unit [302] is further configured to receive in real time from the at least one smart sticker [104], at least one time stamp associated with an impact on the sports equipment [106]. The transceiver unit [302] is also configured to receive in real time from the at least one smart sticker [104] at least one battery level information of a battery [206] placed in the at least one smart sticker [104]. Further, the transceiver unit [302] is also configured to receive in real time from the at least one smart sticker [104], at least one data associated with heath of the at least one smart sticker [104] and the sports equipment [106].

The stump box [102] is also configured to identify by the processing unit [304], at least one of a raw sensor data and a processed sensor data received by at least one of the at least one smart sticker [104], the one or more camera sensors and the one or more microphones.

Further, the stump box [102] is configured to determine, at least one of an impact parameter, a swing parameter, an advanced parameter and an additional parameter based on at least one of the at least one data received from the smart sticker, the data associated with the ball impact, the data associated with the custom tap, the data associated with the one or more camera sensors and the data associated with the one or more microphones. Further, the data associated with the ball impact may comprise an information of an impact of the ball on the sports equipment [106] and the data associated with the custom tap may comprise an information of an impact/force on the sports equipment (for instance cricket bat) [106] other than that of the ball. In a cricket match, the impact parameters may include but not limited to a sports equipment (such as a cricket bat) speed, a bat twist, a shot quality and a shot power etc. The swing parameters may include but not limited to a backlift, a forward swing, a follow through, a face angle, a backlift direction and the like. The advanced parameter may include but not limited to a launch angle, handedness, a shot direction etc. Also, the additional parameter may include but not limited to a starting point of sensors of the smart sticker [104], gravity parameters and the like.

Further, at least one of the smart sticker [104] and the stump box [102] are configured to differentiate between various phases of a shot (such as a batting stance, a backlift, a downswing, a follow-through etc. in a cricket match) using a sensor signal pattern analysis of the one or more accelerometer and one or more gyroscope sensors placed in the smart sticker [104]. Also, the memory unit [306] of the stump box [102] is configured to store the data received from the smart sticker [104] and one or more sensors/units (such as camera units and microphones) present in the sports field.

Furthermore, the memory unit [306] of the stump box [102] is configured to store the sports data received from the smart sticker [104] locally. The invention encompasses storing only some information locally at the memory unit [306] and transmitting other information to the remote storage such as cloud storage. The invention also encompasses transmitting all the data received from the smart sticker [104] to the remote storage while storing a copy of some data at the stump box memory unit [306]. The transmission of data from the smart sticker to the remote storage or cloud storage may be via an electronic device (comprising a receiver, such as a mobile phone) or via the stump box [102] to another electronic device over a wired connection (such as a laptop).

Also, the transceiver unit [302] of the stump box [302] is further configured to transmit to at least one of a boundary device and a server unit [400], at least one of a data received from the smart sticker (i.e. the sports data), a data associated with the ball impact, a data associated with the custom tap and the data associated with at least one of the one or more camera sensors and the one or more microphones. Also, in an implementation the stump box [102] is connected to the at least one boundary device via a wired connection. For example, the stump box [302] may have a high speed Ethernet interface connected to the boundary device.

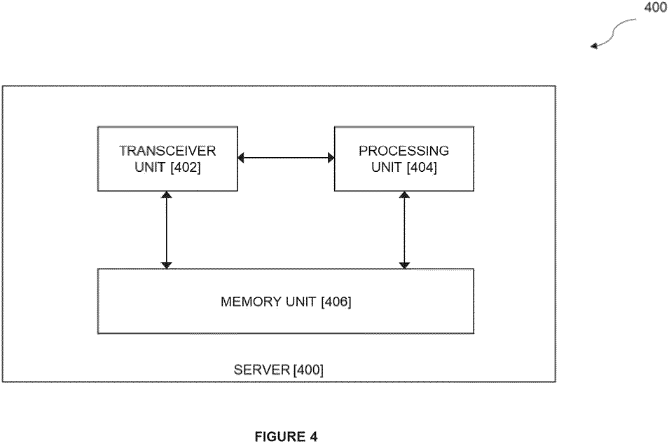

Referring to FIG. 4, an exemplary block diagram of a server/server unit [400] for identifying one of a ball impact and a custom tap, in accordance with exemplary embodiments of the present disclosure is shown.

As shown in FIG. 4, the server unit [400] encompasses at least one transceiver unit [402], at least one processing unit [404] and at least one memory unit [406]. All of these components/ units of the server [400] are assumed to be connected to each other unless otherwise indicated below. Also, in FIG. 4 only few units are shown, however the server [400] may comprise multiple such units or the server [400] may comprise any such numbers of the units, obvious to a person skilled in the art or as required to implement the features of the present disclosure.

The transceiver unit [402] is configured to receive via a stump box [102] in real time from one or more accelerometer sensors [202] placed in at least one smart sticker [104], at least one acceleration data associated with a sports equipment [106], wherein the at least one smart sticker [104] is mounted on the sports equipment [106]. The at least one acceleration data includes but not limited to at least one data associated with an impact on the sports equipment [106]. In an implementation the sports equipment [106] is a cricket bat. In another implementation the sports equipment [106] may be any sports equipment. Also, the transceiver unit [402] is configured to transmit via a stump box [102], at least one command, to the at least one smart sticker [104] for at least one of a collecting, processing and transmitting of at least one sports data by the at least one smart sticker [104]. The at least one sports data includes but not limited to one or more data relating to one or more sensors (such as IMU and accelerometers) placed in the at least one smart sticker, at least one time stamp associated with an impact on the sports equipment [106], at least one battery level information of a battery [206] placed in the at least one smart sticker [104] and at least one data associated with heath of the at least one smart sticker [104] and the sports equipment [106]. Furthermore, the transceiver unit [402] is also configured to receive via a stump box [102], at least one data from one or more camera sensors and one or more microphones present in the sports field.

Further, the server [400] comprises a processing unit [404] connected to the transceiver unit [402]. The processing unit [404] is configured to identify, at least one acceleration pattern based on the at least one acceleration data. Also, the processing unit [404] is configured to identify, at least one correlation value associated with the identified at least one acceleration pattern based on at least one preconfigured acceleration pattern. Further, the processing unit [404] is configured to generate, one of a positive indication and a negative indication based on a comparison of the at least one correlation value with a correlation threshold value, wherein the positive indication is generated in an event the at least one correlation value is lesser than the correlation threshold value, and the negative indication is generated in an event the at least one correlation value is greater than the correlation threshold value. Further, the processing unit [404] is configured to identify, one of the ball impact and the custom tap, wherein the ball impact is identified based on the positive indication and the custom tap is identified based on the negative indication.

Also, the server [400] is configured to determine, at least one of an impact parameter, a swing parameter, an advanced parameter and an additional parameter based on at least one of the at least one data received from the smart sticker, a data associated with the ball impact, a data associated with the custom tap, the data associated with the one or more camera sensors and the data associated with the one or more microphones. Further, the data associated with the ball impact may comprise an information of an impact of the ball on the sports equipment [106] and the data associated with the custom tap may comprise an information of an impact/force on the sports equipment (for instance cricket bat) [106] other than that of the ball. Also, the memory unit [406] of the server [400] is configured to store the data received from the smart sticker [104] and one or more sensors/units (such as camera units and microphones) present in the sports field.

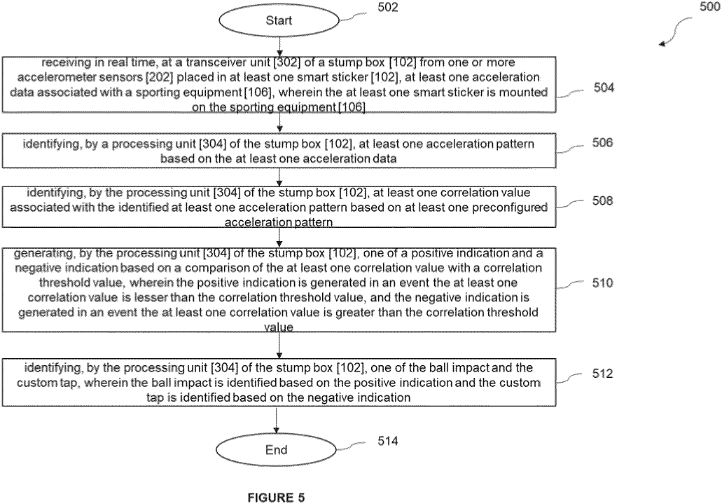

Referring to FIG. 5, an exemplary method flow diagram depicting a method [500] for identifying one of a ball impact and a custom tap, in accordance with exemplary embodiments of the present disclosure is shown. As shown in FIG. 5, the method starts at step [502].

At step [504] the method encompasses receiving in real time, at a transceiver unit [302] of a stump box [102] from one or more accelerometer sensors [202] placed in at least one smart sticker [102], at least one acceleration data associated with a sports equipment [106], wherein the at least one smart sticker is mounted on the sports equipment [106]. In an implementation the stump box [102] is placed in a sports field and the sports equipment [106] may be any sports equipment. In another implementation the stump box [102] is placed near the stumps during a cricket match and the sports equipment [106] is a cricket bat.

Also, the method encompasses transmitting by the transceiver unit [302], at least one command, to the at least one smart sticker [104] for at least one of a collecting, processing and transmitting of at least one sports data by the at least one smart sticker [104]; and receiving in real time such data as mentioned in step 504 in response to said command. The at least one sports data includes but not limited to one or more data relating to one or more sensors (such as IMU and accelerometers) placed in the at least one smart sticker. Also, the method encompasses receiving at the transceiver unit [302] from the at least one smart sticker [104], the at least one sports data over a wireless connection based on an active mode of the at least one smart sticker. Also, in an instance, the wireless connection is a Bluetooth connection.

Furthermore, the method also comprises receiving by the transceiver unit [302], at least one data from one or more camera sensors and one or more microphones present in the sports field.

The at least one acceleration data includes but not limited to at least one data associated with an impact on the sports equipment [106]. The data associated with the impact is determined by the one or more accelerometer sensors [202] based on an analysis of one or more samples of the one or more accelerometer sensors [202] for a fixed period of time, a detection of at least one spike summation value based on the analysis of the one or more samples, and a comparison of the at least one spike summation value with at least a low threshold value.

Next at step [506] the method encompasses identifying, by a processing unit [304] of the stump box [102], at least one acceleration pattern based on the at least one acceleration data.

Further at step [508] the method encompasses identifying, by the processing unit [304] of the stump box [102], at least one correlation value associated with the identified at least one acceleration pattern based on at least one preconfigured acceleration pattern.

Next at step [510] the method encompasses generating, by the processing unit [304] of the stump box [102], one of a positive indication and a negative indication based on a comparison of the at least one correlation value with a correlation threshold value, wherein the positive indication is generated in an event the at least one correlation value is lesser than the correlation threshold value, and the negative indication is generated in an event the at least one correlation value is greater than the correlation threshold value.

Thereafter, at step [512] the method encompasses identifying, by the processing unit [304] of the stump box [102], one of the ball impact and the custom tap, wherein the ball impact is identified based on the positive indication and the custom tap is identified based on the negative indication.

For example, in an exemplary implementation the method encompasses identifying an acceleration pattern such as AXs, AZs as a set of sampled acceleration data in X axis and Z axis correspondingly from an accelerometer sensor and AXr, AZr is a set of reference acceleration data in X axis and Z axis (i.e. preconfigured acceleration pattern) correspondingly for a tap/impact. Thereafter the method encompasses computing a correlation for X axis and Z axis acceleration data and correlation coefficients (i.e. correlation values) for accelerometer sensors are determined.

Further, if mean of the correlation coefficients is greater than a Tap correlation threshold, then a negative indication is generated and the impact is considered as “Tap”, else a positive indication is generated and the impact is considered as “Ball Impact”.

Also, the method encompasses receiving in real time by the transceiver unit [302] from the at least one smart sticker [104], at least one linear dynamic motion data and at least one angular dynamic motion data of the sports equipment [106], wherein the at least one linear dynamic motion data and at least one angular dynamic motion data is received via one or more inertial measurement unit (IMU) [204] placed in the at least one smart sticker [104]. Also, each of the one or more inertial measurement unit [204] further comprises at least one multi-axis accelerometer and at least one multi -axis gyroscope. Also, the method encompasses receiving in real time by the transceiver unit [302] from the at least one smart sticker [104], at least one time stamp associated with an impact on the sports equipment [106]. Furthermore, the method comprises receiving in real time by the transceiver unit [302] from the at least one smart sticker [104] at least one battery level information of a battery [206] placed in the at least one smart sticker [104]. Also, the method encompasses receiving in real time by the transceiver unit [302] from the at least one smart sticker [104], at least one data associated with heath of the at least one smart sticker [104] and the sports equipment [106].

Also, the method comprises identifying by the processing unit [304], at least one of a raw sensor data and a processed sensor data received by at least one of the at least one smart sticker [104], the one or more camera sensors and the one or more microphones.

Further, the method also encompasses differentiating by at least one of the smart sticker [104] and the stump box [102], various phases of a shot (such as a batting stance, a backlift, a downswing, a follow-through etc. in a cricket match) using a sensor signal pattern analysis of the one or more accelerometer and one or more gyroscope sensors placed in the smart sticker [104]. Also, the method comprises storing at the memory unit [306] of the stump box [102], the data received from the smart sticker [104] and one or more sensors/units (such as camera units and microphones) present in the sports field.

Also, the method comprises transmitting by the transceiver unit [302] of the stump box [302] to at least one of a boundary device, a user device and a server unit [400], at least one of a data received from the smart sticker (i.e. the sports data), a data associated with the ball impact, a data associated with the custom tap and the data associated with at least one of the one or more camera sensors and the one or more microphones. Also, in an implementation the stump box [102] is connected to the at least one boundary device via a wired connection. For example, the stump box [302] may have a high speed Ethernet interface connected to the boundary device.

Thereafter, the method encompasses determining by at least one of the stump box [102], the at least one boundary device, the user device and the server unit [400], at least one of an impact parameter, a swing parameter, an advanced parameter and an additional parameter based on at least one of the at least one data received from the smart sticker, the data associated with the ball impact, the data associated with the custom tap, the data associated with the one or more camera sensors and the data associated with the one or more microphones. Further, the data associated with the ball impact may comprise an information of an impact of the ball on the sports equipment [106] and the data associated with the custom tap may comprise an information of an impact/force on the sports equipment (for instance cricket bat) [106] other than that of the ball. In a cricket match the impact parameters may include but not limited to a sports equipment (such as a cricket bat) speed, a bat twist, a shot quality and a shot power etc. The swing parameters may include but not limited to a backlift, a forward swing, a follow through, a face angle, a backlift direction and the like. The advanced parameter may include but not limited to a launch angle, handedness, a shot direction etc. Also, the additional parameter may include but not limited to a starting point of sensors of the smart sticker [104], gravity parameters and the like.

The method further terminates at step [514].

As evident from the above disclosure, the present solution provides significant technical advancement over the existing solutions by identifying one of a ball impact, a custom tap and one or more sports parameters (such as impact parameters, swing parameters etc.) based on at least one sports data associated with a sports equipment. Furthermore, the present solution encompasses the use of a smart sticker comprising at least of one or more sensors (such as acceleration sensors and IMU) to collect and analyze the sports data in a more efficient and effective way. Also, as only a single acceleration sensor of a smart sticker can be used to identify an impact on a sports equipment the limitation of prior known solutions such as the use of multiple sensors (for instance at least three piezo sensors) to identify an impact is overcome by the present solution. Furthermore, the stored sports data can be later used for analysis by various kinds of users such as sportsmen to analyze and improve; coaches to analyze and use for training purposes; broadcasters for relaying such data along with the live broadcast of the match; etc.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

1. A method for identifying one of a ball impact and a custom tap, the method comprising:
receiving in real time, at a transceiver unit of a stump box from one or more accelerometer sensors placed in at least one smart sticker, at least one acceleration data associated with a sports equipment, wherein the at least one smart sticker is mounted on the sports equipment;
identifying, by a processing unit of the stump box, at least one acceleration pattern based on the at least one acceleration data;
identifying, by the processing unit of the stump box, at least one correlation value associated with the identified at least one acceleration pattern based on at least one preconfigured acceleration pattern;
generating, by the processing unit of the stump box, one of a positive indication and a negative indication based on a comparison of the at least one correlation value with a correlation threshold value, wherein:
the positive indication is generated in an event the at least one correlation value is lesser than the correlation threshold value, and
the negative indication is generated in an event the at least one correlation value is greater than the correlation threshold value; and
identifying, by the processing unit of the stump box, one of the ball impact and the custom tap, wherein the ball impact is identified based on the positive indication and the custom tap is identified based on the negative indication.

2. The method as claimed in claim 1, wherein the sports equipment is a cricket bat.

3. The method as claimed in claim 1, wherein the stump box is placed in a sports field.

4. The method as claimed in claim 1, the method further comprises receiving in real time, at the transceiver unit of the stump box from the at least one smart sticker:
at least one linear dynamic motion data and at least one angular dynamic motion data of the sports equipment, wherein the at least one linear dynamic motion data and at least one angular dynamic motion data is received via one or more inertial measurement unit (IMU) placed in the at least one smart sticker,
at least one time stamp associated with an impact on the sports equipment,
at least one battery level information of a battery placed in the at least one smart sticker, and
at least one data associated with heath of the at least one smart sticker and the sports equipment .

5. The method as claimed in claim 3, wherein each of the one or more inertial measurement unit further comprises at least one multi-axis accelerometer and at least one multi-axis gyroscope.

6. The method as claimed in claim 1, wherein the at least one acceleration data further comprises at least one data associated with the impact on the sports equipment , wherein the data associated with the impact is determined by the one or more accelerometer sensors based on:
an analysis of one or more samples of the one or more accelerometer sensors for a fixed period of time,
a detection of at least one spike summation value based on the analysis of the one or more samples, and
a comparison of the at least one spike summation value with at least a low threshold value.

7. The method as claimed in claim 1, the method further comprises transmitting, by the transceiver unit of the stump box , at least one command, to the at least one smart sticker for at least one of a collecting, processing and transmitting of at least one sports data by the at least one smart sticker, wherein the at least one sports data comprises one or more data relating to one or more sensors placed in the at least one smart sticker .

8. The method as claimed in claim 1, the method further comprises receiving at the transceiver unit of the stump box from the at least one smart sticker, the at least one sports data over a wireless connection based on an active mode of the at least one smart sticker .

9. The method as claimed in claim 9, wherein the wireless connection is a Bluetooth connection.

10. The method as claimed in claim 1, the method further comprises receiving at the stump box , at least one data from one or more camera sensors and one or more microphones present in the sports field.

11. The method as claimed in claim 10, the method further comprises identifying by the stump box at least one of a raw sensor data and a processed sensor data received by at least one of the at least one smart sticker , the one or more camera sensors and the one or more microphones.

12. The method as claimed in claim 11 the method further comprises transmitting by the stump box to at least one of a boundary device and a server unit , at least one of a data received from the smart sticker, a data associated with the ball impact, a data associated with the custom tap and the data associated with at least one of the one or more camera sensors and the one or more microphones.

13. The method as claimed in claim 12, wherein the stump box is connected to the at least one boundary device via a wired connection.

14. The method as claimed in claim 13, the method further comprises determining by at least one of the stump box , the at least one boundary device and the server unit , at least one of an impact parameter, a swing parameter, an advanced parameter and an additional parameter based on the at least one of the at least one data received from the smart sticker, the data associated with the ball impact, the data associated with the custom tap, the data associated with the one or more camera sensors and the data associated with the one or more microphones.

15. A stump box for identifying one of a ball impact and a custom tap, the stump box comprising:
a transceiver unit , configured to receive in real time from one or more accelerometer sensors placed in at least one smart sticker, at least one acceleration data associated with a sports equipment, wherein the at least one smart sticker is mounted on the sports equipment;
a processing unit configured to:
identify, at least one acceleration pattern based on the at least one acceleration data,
identify, at least one correlation value associated with the identified at least one acceleration pattern based on at least one preconfigured acceleration pattern, generate, one of a positive indication and a negative indication based on a comparison of the at least one correlation value with a correlation threshold value, wherein:
the positive indication is generated in an event the at least one correlation value is lesser than the correlation threshold value, and the negative indication is generated in an event the at least one correlation value is greater than the correlation threshold value, and
identify, one of the ball impact and the custom tap, wherein the ball impact is identified based on the positive indication and the custom tap is identified based on the negative indication.

16. The stump box as claimed in claim 15, wherein the sports equipment is a cricket bat.

17. The stump box as claimed in claim 15, wherein the stump box is placed in a sports field.

18. The stump box as claimed in claim 15, wherein the transceiver unit is further configured to receive in real time from the at least one smart sticker :
at least one linear dynamic motion data and at least one angular dynamic motion data of the sports equipment , wherein the at least one linear dynamic motion data and at least one angular dynamic motion data is received via one or more inertial measurement unit (IMU) placed in the at least one smart sticker,
at least one time stamp associated with an impact on the sports equipment,
at least one battery level information of a battery placed in the at least one smart sticker, and
at least one data associated with heath of the at least one smart sticker and the sports equipment .

19. The stump box as claimed in claim 18, wherein each of the one or more inertial measurement unit further comprises at least one multi-axis accelerometer and at least one multi-axis gyroscope.

20. The stump box as claimed in claim 15, wherein the at least one acceleration data further comprises at least one data associated with the impact on the sports equipment, wherein the data associated with the impact is determined by the one or more accelerometer sensors based on:
an analysis of one or more samples of the one or more accelerometer sensors for a fixed period of time,
a detection of at least one spike summation value based on the analysis of the one or more samples, and
a comparison of the at least one spike summation value with at least a low threshold value.

21. The stump box as claimed in claim 15, wherein the transceiver unit is further configured to transmit at least one command, to the at least one smart sticker for at least one of a collecting, processing and transmitting of at least one sports data by the at least one smart sticker, wherein the at least one sports data comprises one or more data relating to one or more sensors placed in the at least one smart sticker.

22. The stump box as claimed in claim 16, wherein the transceiver unit is further configured to receive from the at least one smart sticker, the at least one sports data over a wireless connection based on an active mode of the at least one smart sticker.

23. The stump box as claimed in claim 22, wherein the wireless connection is a Bluetooth connection.

24. The stump box as claimed in claim 15, wherein the transceiver unit is further configured to receive, at least one data from one or more camera sensors and one or more microphones present in the sports field.

25. The stump box as claimed in claim 24, wherein the stump box is further configured to identify at least one of a raw sensor data and a processed sensor data received by at least one of the at least one smart sticker, the one or more camera sensors and the one or more microphones.

26. The stump box as claimed in claim 24, wherein the transceiver unit of the stump box is further configured to transmit to at least one of a boundary device and a server unit, at least one of a data received from the smart sticker, a data associated with the ball impact, a data associated with the custom tap and the data associated with at least one of the one or more camera sensors and the one or more microphones.

27. The stump box as claimed in claim 26, wherein the stump box is connected to the at least one boundary device via a wired connection.

28. The stump box as claimed in claim 27, wherein the stump box is further configured to determine, at least one of an impact parameter, a swing parameter, an advanced parameter and an additional parameter based on at least one of the at least one data received from the smart sticker, the data associated with the ball impact, the data associated with the custom tap, the data associated with the one or more camera sensors and the data associated with the one or more microphones.

29. A server for identifying one of a ball impact and a custom tap, the server comprising:
a transceiver unit , configured to receive via a stump box in real time from one or more accelerometer sensors placed in at least one smart sticker , at least one acceleration data associated with a sports equipment, wherein the at least one smart sticker is mounted on the sports equipment;
a processing unit configured to:
identify, at least one acceleration pattern based on the at least one acceleration data,
identify, at least one correlation value associated with the identified at least one acceleration pattern based on at least one preconfigured acceleration pattern, generate, one of a positive indication and a negative indication based on a comparison of the at least one correlation value with a correlation threshold value, wherein:
the positive indication is generated in an event the at least one correlation value is lesser than the correlation threshold value, and
the negative indication is generated in an event the at least one correlation value is greater than the correlation threshold value, and
identify, one of the ball impact and the custom tap, wherein the ball impact is identified based on the positive indication and the custom tap is identified based on the negative indication.
